(19) United States
(12) Patent Application Publication
(10) Pub. No.: US 2005/0225786 A1
(43) Pub. Date: Oct. 13, 2005

(54) Tone control method

(75) Inventor: Satoru Kiyohara, Kyoto (JP)

Correspondence Address: MCDERMOTT WILL & EMERY LLP, 600 13TH STREET, N.W., WASHINGTON, DC, 20005-3096, US

(73) Assignee: DAINIPPON SCREEN MFG. CO., LTD.

(21) Appl. No.: 11/079,343

(22) Filed: Mar. 15, 2005

(30) Foreign Application Priority Data
Apr. 12, 2004 (JP) 2004-116570

(51) Int. Cl. H04N 1/56; H04N 1/60

(52) U.S. Cl. 358/1.9; 358/504; 358/521

(57) ABSTRACT

A tone control method for creating data for controlling ink feeding rates of a printing machine, by comparing image data serving as a reference and image data obtained by reading an image from an actual print. The method includes a control point determining step for determining a plurality of control points for each area corresponding to ink keys in each ink well of the printing machine, a weight factor calculating step for calculating a weight factor of each of the control points determined in the control point determining step, by using a color spread of each control point, a color purity of each control point and a dot percent of each control point, and a calculating step for calculating color values for controlling the ink feeding rates, by totaling, for all of the control points, products of the color values and the weight factor of each of the control points.

### BACKGROUND OF THE INVENTION

1. Field of the Invention

This invention relates to a tone control method for use in controlling ink feeding rates of a printing machine.

2. Description of the Related Art

In order to perform proper printing with a printing machine, it is necessary to control ink feeding rates properly. For controlling the ink feeding rates, it has been conventional practice to measure densities of control strips with a densitometer and determine from density data whether the ink feeding rates are proper or not. However, the density data from the control strips alone is not necessarily sufficient for attaining a proper color tone and the like for a picture area.

For this reason, a tone control method is used which provides control data for controlling the ink feeding rates of a printing machine. The control data is produced by comparing an image on reference paper and images on actual prints.

The reference paper is also called proof paper, which serves as a reference indicating a color tone of finished prints to obtain proper prints. Image data of the reference paper can be obtained by reading the image of the reference paper with an image pickup device. Instead of obtaining the image data by reading the image of the reference paper, it is possible to use image data used in time of platemaking, or image data obtained by processing this image data.

The actual prints are also called sampling sheets which may be sheets of printing paper extracted by the operator from a discharge station of a printing machine at certain intervals during a printing operation. Image data of the actual prints may be obtained by reading images of the printing paper with the image pickup device. Alternatively, image data of the actual prints may be obtained by reading images of printing paper, immediately after the images are printed thereon, at an image pickup station disposed adjacent the discharge station of the printing machine.

For example, calorimetric values or density values of colors (which are hereinafter collectively called “color values”) based on both image data are compared. The printing is considered proper when the color tone of the sampling sheets substantially coincides with the color tone of the reference paper. At this time, it is difficult to attain an agreement in color tone and the like in all areas between the image on the reference paper and the image on the actual prints. For this reason, a control point (which is a representative point for use in controlling color tone) are selected from these images, and a comparison is made between the color values at the control point of the image on the reference paper, and those at the control point of the image on the actual prints.

The control point is, for example, a representative point having a representative color that characterizes the image on the prints. This representative point is selected manually by the operator while observing the image. Japanese Unexamined Patent Publication No. 2004-50609 discloses a print quality measuring apparatus that can automatically determine such a representative point.

The print quality measuring apparatus described in the above publication is effective for printing proper images. However, where a problem occurs with the uniformity over the surface of a print, such as a difference in printed color between the upper end region and lower end region of the print, proper prints cannot be obtained even when a tone control is carried out using a single control point. Further, the prints obtained by using a single control point could prove unsatisfactory owing to an error in the measurement of the control point.

### SUMMARY OF THE INVENTION

The object of this invention, therefore, is to provide a tone control method that uses a plurality of control points to produce proper prints at all times.

The above object is fulfilled, according to this invention, by a tone control method for creating data for controlling ink feeding rates of a printing machine, by comparing color values derived from data serving as a reference and color values derived from data obtained by reading an image from an actual print, the method comprising a control point determining step for determining a plurality of control points for use in a tone control, a weight factor calculating step for calculating a weight factor of each of the control points determined in the control point determining step, and a color value calculating step for calculating color values for controlling the ink feeding rates, based on color values and the weight factor of each of the control points.

This tone control method, by using a plurality of control points, can produce proper prints at all times.

In a preferred embodiment of the invention, the weight factor calculating step is executed to calculate a weight factor by using at least one of a color spread of each control point, a color purity of each control point and a dot percent of each control point.

The weight factor calculating step may be executed to determine the color spread of each control point by using a color distribution of an area around each control point.

In another preferred embodiment of the invention, the color value calculating step is executed to calculate color values for controlling the ink feeding rates by totaling, for all of the control points, products of the color values and the weight factor of each of the control points.

In another aspect of the invention, a tone control method is provided for creating data for controlling ink feeding rates of a printing machine, by comparing color values derived from image data serving as a reference and color values derived from image data obtained by reading an image from an actual print, the method comprising a control point determining step for determining a plurality of control points for use in a tone control, a weight factor calculating step for calculating a weight factor of each of the control points determined in the control point determining step, by multiplying the weight factor by at least one of a color spread of each control point, a color purity of each control point and a dot percent of each control point, and a color value calculating step for calculating color values for controlling the ink feeding rates, by totaling, for all of the control points, products of the color values and the weight factor of each of the control points.

Other features and advantages of the invention will be apparent from the following detailed description of the embodiments of the invention.

### BRIEF DESCRIPTION OF THE DRAWINGS

For the purpose of illustrating the invention, there are shown in the drawings several forms which are presently preferred, it being understood, however, that the invention is not limited to the precise arrangement and instrumentalities shown.

FIG. 1 is a schematic side view of a printing machine according to this invention;

FIG. 2 is a schematic view showing an image pickup station along with a paper discharge mechanism such as a paper discharge cylinder;

FIG. 3 is a block diagram showing a principal electrical structure of the printing machine;

FIG. 4 is a flow chart of a tone control operation;

FIG. 5 is an explanatory view showing an image serving as a reference displayed on a control panel, and control points determined on the image;

FIG. 6 is a perspective view of a print quality measuring apparatus according to this invention;

FIG. 7 is a side view of the print quality measuring apparatus; and

FIG. 8 is a block diagram showing a principal structure of a control unit.

### DESCRIPTION OF THE PREFERRED EMBODIMENTS

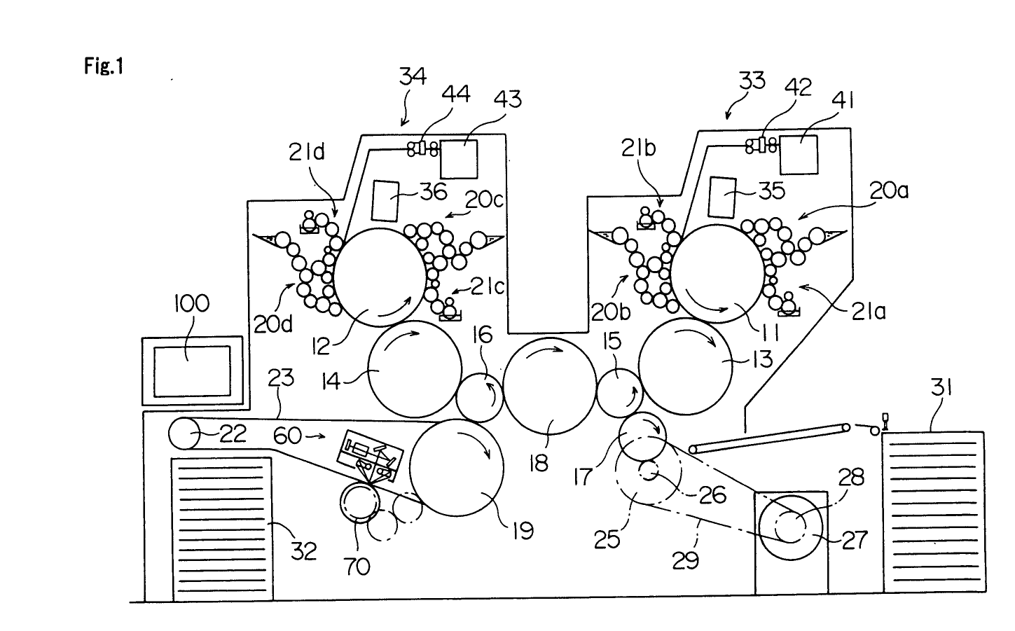

An embodiment of this invention will be described hereinafter with reference to the drawings. The construction of a printing machine according to this invention will be described first. FIG. 1 is a schematic view of the printing machine according to this invention.

This printing machine records images on blank plates mounted on first and second plate cylinders 11 and 12 in a prepress process, feeds inks to the plates having the images recorded thereon, and transfers the inks from the plates through first and second blanket cylinders 13 and 14 to printing paper held on first and second impression cylinders 15 and 16, thereby printing the images in four colors on the printing paper.

The printing machine has the first plate cylinder 11, the second plate cylinder 12, the first blanket cylinder 13 contactable with the first plate cylinder 11, the second blanket cylinder 14 contactable with the second plate cylinder 12, the first impression cylinder 15 contactable with the first blanket cylinder 13, and the second impression cylinder 16 contactable with the second blanket cylinder 14. The printing machine further includes a paper feed cylinder 17 for transferring printing paper supplied from a paper storage station 31 to the first impression cylinder 15, a transfer cylinder 18 for transferring the printing paper from the first impression cylinder 15 to the second impression cylinder 16, a paper discharge cylinder 19 with chains 23 wound thereon and extending to and wound on sprockets 22 for discharging printed paper from the second impression cylinder 16 to a paper discharge station 32, an image pickup station 60 for reading images and measuring densities of detecting patches printed on the printing paper, and a control panel 100 of the touch panel type.

Each of the first and second plate cylinders 11 and 12 is what is called a two-segmented cylinder for holding two printing plates peripherally thereof for printing in two different colors. The first and second blanket cylinders 13 and 14 have the same diameter as the first and second plate cylinders 11 and 12, and each has blanket surfaces for transferring images in two colors.

The first and second impression cylinders 15 and 16 movable into contact with the first and second blanket cylinders 13 and 14, respectively, have half the diameter of the first and second plate cylinders 11 and 12 and the first and second blanket cylinders 13 and 14. The first and second impression cylinders 15 and 16 have grippers, not shown, for holding and transporting the forward end of printing paper.

The paper feed cylinder 17 disposed adjacent the first impression cylinder 15 has the same diameter as the first and second impression cylinders 15 and 16. The paper feed cylinder 17 has a gripper, not shown, for holding and transporting, with each intermittent rotation of the feed cylinder 17, the forward end of each sheet of printing paper fed from the paper storage station 31. When the printing paper is transferred from the feed cylinder 17 to the first impression cylinder 15, the gripper of the first impression cylinder 15 holds the forward end of the printing paper which has been held by the gripper of the feed cylinder 17.

The transfer cylinder 18 disposed between the first impression cylinder 15 and second impression cylinder 16 has the same diameter as the first and second plate cylinders 11 and 12 and the first and second blanket cylinders 13 and 14. The transfer cylinder 18 has a gripper, not shown, for holding and transporting the forward end of the printing paper received from the first impression cylinder 15, and transferring the forward end of the printing paper to the gripper of the second impression cylinder 16.

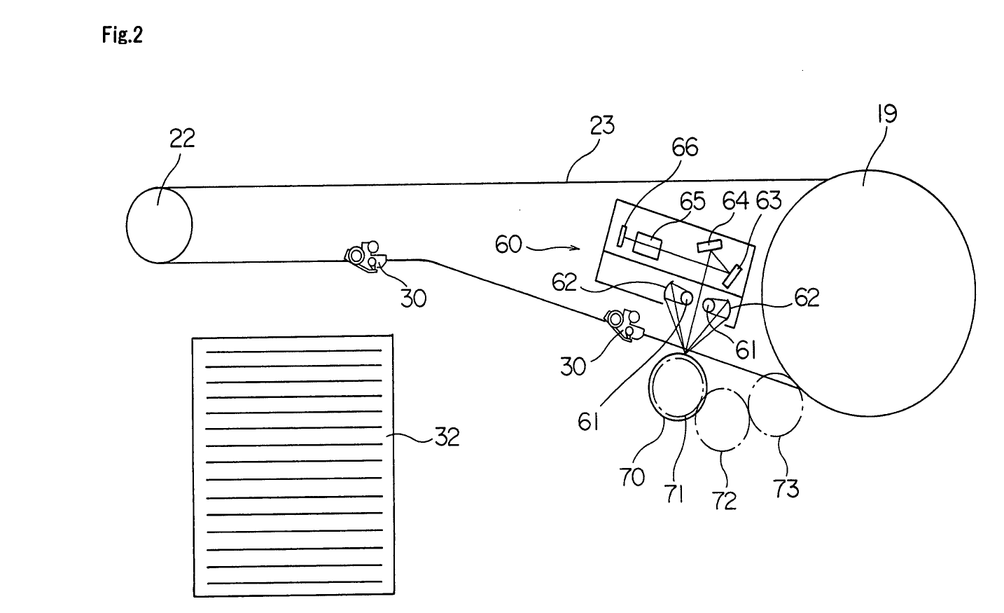

The paper discharge cylinder 19 disposed adjacent the second impression cylinder 16 has the same diameter as the first and second plate cylinders 11 and 12 and the first and second blanket cylinders 13 and 14. The discharge cylinder 19 has a pair of chains 23 wound around opposite ends thereof. The chains 23 are interconnected by coupling members, not shown, having a plurality of grippers 30 (FIG. 2). When the second impression cylinder 16 transfers the printing paper to the discharge cylinder 19, one of the grippers 30 on the discharge cylinder 17 holds the forward end of the printing paper having been held by the gripper of the second impression cylinder 16. With movement of the chains 23, the printing paper is transported to the paper discharge station 32 to be discharged thereon.

The paper feed cylinder 17 has a gear attached to an end thereof and connected to a gear 26 disposed coaxially with a driven pulley 25. A belt 29 is wound around and extends between the driven pulley 25 and a drive pulley 28 rotatable by a motor 27. Thus, the paper feed cylinder 17 is rotatable by drive of the motor 27. The first and second plate cylinders 11 and 12, first and second blanket cylinders 13 and 14, first and second impression cylinders 15 and 16, paper feed cylinder 17, transfer cylinder 18 and paper discharge cylinder 19 are coupled to one another by gears attached to ends thereof, respectively. Thus, by the drive of motor 27, the paper feed cylinder 17, first and second impression cylinders 15 and 16, paper discharge cylinder 19, first and second blanket cylinders 13 and 14, first and second plate cylinders 11 and 12 and transfer cylinder 18 are rotatable synchronously with one another.

The first plate cylinder 11 is surrounded by an ink feeder 20a for feeding an ink of black (K), for example, to a plate, an ink feeder 20b for feeding an ink of cyan (C), for example, to a plate, and dampening water feeders 21a and 21b for feeding dampening water to the plates. The second plate cylinder 12 is surrounded by an ink feeder 20c for feeding an ink of magenta (M), for example, to a plate, an ink feeder 20d for feeding an ink of yellow (Y), for example, to a plate, and dampening water feeders 21c and 21d for feeding dampening water to the plates.

Further, arranged around the first and second plate cylinders 11 and 12 are a plate feeder 33 for feeding plates to the peripheral surface of the first plate cylinder 11, a plate feeder 34 for feeding plates to the peripheral surface of the second plate cylinder 12, an image recorder 35 for recording images on the plates mounted peripherally of the first plate cylinder 11, and an image recorder 36 for recording images on the plates mounted peripherally of the second plate cylinder 12.

FIG. 2 is a schematic side view showing the image pickup station 60 for reading images and measuring densities of detecting patches printed on the printing paper, along with the paper discharge mechanism such as the paper discharge cylinder 19.

The pair of chains 23 are endlessly wound around the opposite ends of the paper discharge cylinder 19 and the pair of sprockets 22. As noted hereinbefore, the chains 23 are interconnected by coupling members, not shown, having a plurality of grippers 30 arranged thereon each for gripping the forward end of printing paper transported. FIG. 2 shows only two grippers 30, with the other grippers 30 omitted.

The pair of chains 23 have a length corresponding to a multiple of the circumference of first and second impression cylinders 15 and 16. The grippers 30 are arranged on the chains 23 at intervals each corresponding to the circumference of first and second impression cylinders 15 and 16. Each gripper 30 is opened and closed by a cam mechanism, not shown, synchronously with the gripper on the paper discharge cylinder 19. Thus, each gripper 30 receives the printing paper from the paper discharge cylinder 19, transports the printing paper with rotation of the chains 23, and is then opened by the cam mechanism, not shown, to discharge the paper on the paper discharge station 32.

The printing paper is transported with only the forward end thereof held by one of the grippers 30, the rear end of printing paper not being fixed. Consequently, the printing paper could flap during transport, which impairs operations, to be described hereinafter, of the image pickup station 60 to read images and measure densities of the detecting patches. To avoid such an inconvenience, this printing machine provides a suction roller 70 disposed upstream of the paper discharge station 32 for stabilizing the printing paper transported.

The suction roller 70 is in the form of a hollow roller having a surface defining minute suction bores, with the hollow interior thereof connected to a vacuum pump not shown. The suction roller 70 has a gear 71 attached to an end thereof. The gear 71 is connected through idler gears 72 and 73 to the gear attached to an end of the paper discharge cylinder 19. Consequently, the suction roller 43 is driven to rotate in a matching relationship with a moving speed of the grippers 30. Thus, the printing paper is sucked to the surface of the suction roller 70, thereby being held against flapping when passing over the suction roller 70. In place of the suction roller 70, a suction plate may be used to suck the printing paper two-dimensionally.

The above image pickup station 60 includes a pair of linear light sources 61 extending parallel to the suction roller 70 for illuminating the printing paper on the suction roller 70, a pair of condensing plates 62, reflecting mirrors 63 and 64, a condensing lens 65 and a CCD line sensor 66. The printing paper transported by the paper discharge mechanism including the paper discharge cylinder 19 and chains 23 is illuminated by the pair of linear light sources 61, and photographed by the CCD line sensor 66. The image of the printing paper and density data are displayed on the control panel 100 of the touch panel type.

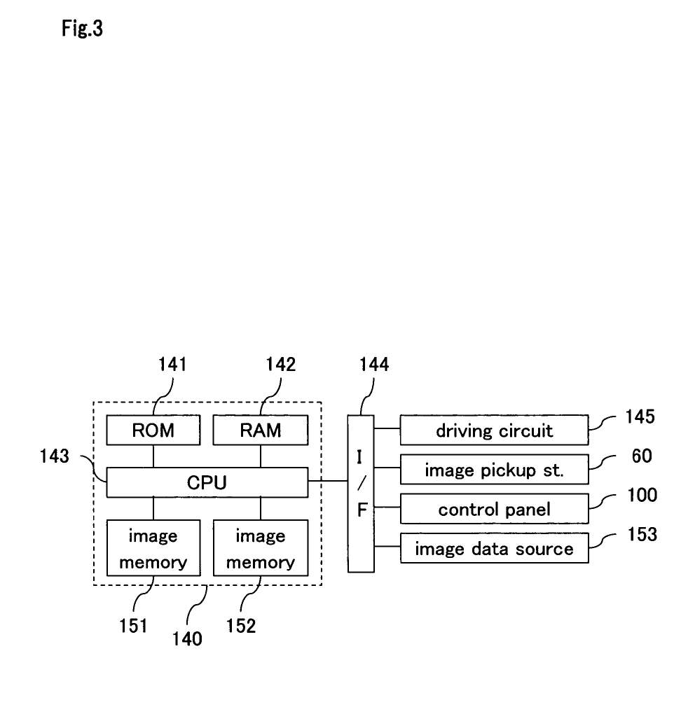

FIG. 3 is a block diagram showing a principal electrical structure of the printing machine. The machine includes a control unit 140 having a ROM 141 for storing operating programs necessary for controlling the machine, a RAM 142 for temporarily storing data and the like during a control operation, and a CPU 143 for performing logic operations. The control unit 140 has a driving circuit 145 connected thereto through an interface 144, for generating driving signals for driving the ink feeders 20, dampening water feeders 21, image recorders 35 and 36, and contact mechanisms for moving the first and second blanket cylinders 35 and 36. The printing machine is controlled by the control unit 140 to perform prepress and printing operations described hereinafter.

The control unit 140 includes a first and a second image memories 151 and 152 described hereinafter. The control unit 140 is connected also to the image pickup station 60 and control panel 100 through the interface 144. Further, the control unit 140 is connected also to an image data source 153 described hereinafter.

In the printing machine having the above construction, a printing plate stock drawn from a supply cassette 41 of the plate feeder 33 is cut to a predetermined size by a cutter 42. The forward end of each plate in cut sheet form is guided by guide rollers and guide members, not shown, and is clamped by clamps of the first plate cylinder 11. Then, the first plate cylinder 11 is driven by a motor, not shown, to rotate at low speed, whereby the plate is wrapped around the peripheral surface of the first plate cylinder 11. The rear end of the plate is clamped by other clamps of the first plate cylinder 11. While, in this state, the first plate cylinder 11 is rotated at low speed, the image recorder 35 irradiates the surface of the plate mounted peripherally of the first plate cylinder 11 with a modulated laser beam for recording an image thereon.

Similarly, a printing plate stock drawn from a supply cassette 43 of the plate feeder 34 is cut to the predetermined size by a cutter 44. The forward end of each plate in cut sheet form is guided by guide rollers and guide members, not shown, and is clamped by clamps of the second plate cylinder 12. Then, the second plate cylinder 12 is driven by a motor, not shown, to rotate at low speed, whereby the plate is wrapped around the peripheral surface of the second plate cylinder 12. The rear end of the plate is clamped by other clamps of the second plate cylinder 12. While, in this state, the second plate cylinder 12 is rotated at low speed, the image recorder 36 irradiates the surface of the plate mounted peripherally of the second plate cylinder 12 with a modulated laser beam for recording an image thereon.

The first plate cylinder 11 has, mounted peripherally thereof, a plate for printing in black ink and a plate for printing in cyan ink. The two plates are arranged in evenly separated positions (i.e. in positions separated from each other by 180 degrees). The image recorder 35 records images on these plates. Similarly, the second plate cylinder 12 has, mounted peripherally thereof, a plate for printing in magenta ink and a plate for printing in yellow ink. The two plates also are arranged in evenly separated positions, and the image recorder 36 records images on these plates, to complete a prepress process.

The prepress process is followed by a printing process for printing the printing paper with the plates mounted on the first and second plate cylinders 11 and 12. This printing process is carried out as follows.

First, each dampening water feeder 21 and each ink feeder 20 are placed in contact with only a corresponding one of the plates mounted on the first and second plate cylinders 11 and 12. Consequently, dampening water and inks are fed to the plates from the corresponding water feeders 21 and ink feeders 20, respectively. These inks are transferred from the plates to the corresponding regions of the first and second blanket cylinders 13 and 14, respectively.

Then, the printing paper is fed to the paper feed cylinder 17. The printing paper is subsequently passed from the paper feed cylinder 17 to the first impression cylinder 15. The impression cylinder 15 having received the printing paper continues to rotate. Since the first impression cylinder 15 has half the diameter of the first plate cylinder 11 and the first blanket cylinder 13, the black ink is transferred to the printing paper wrapped around the first impression cylinder 15 in its first rotation, and the cyan ink in its second rotation.

After the first impression cylinder 15 makes two rotations, the printing paper is passed from the first impression cylinder 15 to the second impression cylinder 16 through the transfer cylinder 18. The second impression cylinder 16 having received the printing paper continues to rotate. Since the second impression cylinder 16 has half the diameter of the second plate cylinder 12 and the second blanket cylinder 14, the magenta ink is transferred to the printing paper wrapped around the second impression cylinder 16 in its first rotation, and the yellow ink in its second rotation.

The forward end of the printing paper printed in the four colors in this way is passed from the second impression cylinder 16 to the paper discharge cylinder 19. The printing paper is transported by the pair of chains 23 toward the paper discharge station 32 to be discharged thereon. At this time, the printing paper being transported is illuminated by the pair of linear light sources 61, and is photographed by the CCD line sensor 66. The photographed image is displayed on the control panel 100.

After the printing process, the printing paper printed is discharged. The first and second blanket cylinders 13 and 14 are cleaned by a blanket cylinder cleaning device, not shown, to complete the printing process.

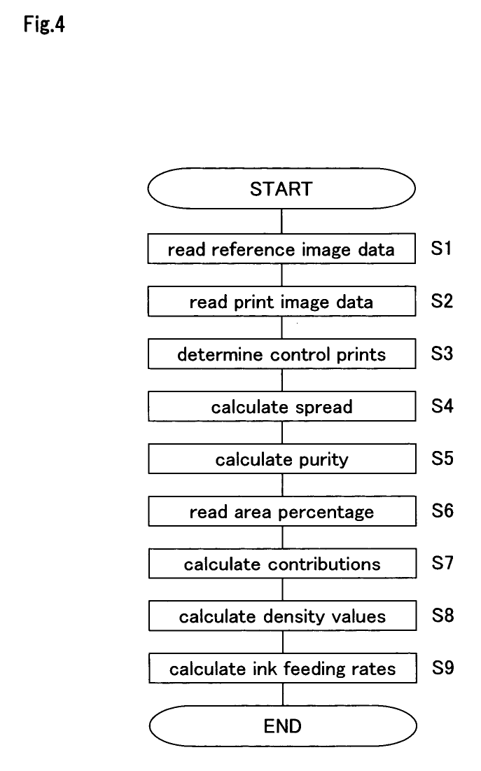

A tone control operation of the above printing machine will be described next. This operation is carried out to create data for controlling ink feeding rates. FIG. 4 is a flow chart of the tone control operation.

In the following embodiment, density values of YMCK colors at control points are calculated for the tone control. Instead, density values of a different color system such as RGB may be used. Colorimetric values such as of L*a*b* may be used.

In order to perform a tone control, image data to be used as reference is fetched first (step S1). This reference image data is stored in the first image memory 151 shown in FIG. 3. The reference image data is supplied from the image data source 153 shown in FIG. 3. The reference image data is obtained by reading the image of reference paper. The reference paper is also called proof paper, and serves as a reference indicating a color tone of finished prints to obtain proper prints. However, platemaking data used in time of platemaking or image data obtained by processing this platemaking data may be used as reference image data.

Next, image data obtained by reading the image of an actual print at the image pickup station 60 is fetched (step S2). The image data of the actual print is stored in the second image memory 152 shown in FIG. 3.

Next, control points to be used in the tone control are determined (step S3). The control points used herein are, for example, representative points having representative colors characterizing the image to be printed. A plurality of such control points are determined for each area corresponding to the ink keys in each ink well of the printing machine. The control points may be determined manually by the operator who looks at the image used as the reference displayed on the control panel 100, or automatically by using the image data of a reference image as described in Japanese Unexamined Patent Publication No. 2004-50609 noted hereinbefore.

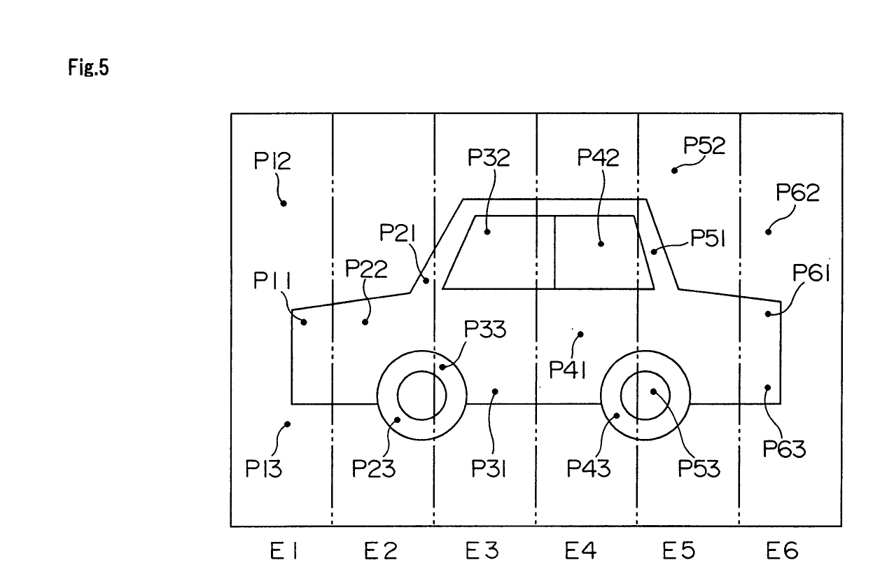

FIG. 5 is an explanatory view showing a reference image displayed on the control panel 100, and control points P11-P63 determined.

In this embodiment, the image is divided into six areas E1-E6 corresponding to the ink keys. Three control points are determined for each of the areas E1-E6. The control points P11-P63 are given an order of priority in each of the areas E1-E6. In this embodiment, each area includes only three control points for expediency of description. This is not limitative, but any number of control points may be set to each area, or different numbers of control points may be set to different areas.

In this embodiment, the control points are first determined on the image data used as the reference, and then points in the positions corresponding to the above control points are determined as control points on image data taken from an actual print. A method of accurately determining control points on image data of an actual print in relation to reference image data is disclosed in Japanese Unexamined Patent Publication No. 2004-42517, for example, and will not particularly be described herein.

Control points may be determined on the image data obtained by reading an actual print, thereafter determining corresponding control points on the reference image data.

Referring again to FIG. 4, a contribution or weight factor of each control point is calculated next, using a color spread, color purity and dot percent of each control point. The weight factor is calculated for each image data, for each area, and for each color of Y, M, C and K.

First, a color spread A of each control point is calculated (step S4). When a control point has a color extending over a large area, this control point is effective and should preferably be given a large weight factor. A color distribution is used for calculating the color spread A.

That is, an average density value of an area n×m around each control point is calculated. Next, a distribution of an area (n+a)×(m+b) around the control point is determined. Specifically, a distribution is derived from the following equation which divides by X a square of a difference between the density at each point and the average density:
[(Y₁−Y₀)²+(Y₂−Y₀)²+(Y₃−Y₀)² . . . (Y_{X}−Y₀)²]/x
where Y0 is an average density in the case of yellow, X=(n+a)×(m+b), and Y₁, Y₂, Y₃ . . . Y_{X} are densities in the case of yellow at different points in the area (n+a)×(m+b).

An upper limit and a lower limit are set to the distribution derived from this equation, and a value normalized in a range of 0.0 to 1.0, for example, is set as color spread A.

Next, color purity CP at each control point is calculated (step S5). A point with a high degree of color purity CP requires no color separation, and enables the control to be performed with increased effect. When calculating purity CP of color C from a YMCK image, purity CP may be derived from the following equation:
CP=C₁/[Y₁+M₁+C₁+K₁]
where Y₁, M₁, C₁ and K₁ are density values of the respective colors at each control point.

Next, dot percent CV at each control point is fetched (step S6). A point with a small dot percent CV is subject to a large error in conversion from halftone density to solid density. It is considered, therefore, that the larger dot percent CV makes the more effective control point.

Then, a weight factor is calculated (step S7). The weight factor is calculated as set out hereunder. Taking color C, for example, weight factor value CC at each control point may be derived from the following equation:
CC=A×CP×CV

Color spread A, color purity CP and dot percent CV at each control point may be weighted by applying a coefficient to the respective values thereof.

In this embodiment, three control points are determined for each of the areas E1-E6. Thus, three weight factor values CC1, CC2 and CC3 are obtained for the control points. Weight factors CCi1, CCi2 and CCi3 of the three control points may be derived from the following equations:
CCi1=CC1/[CC1+CC2+CC3]
CCi2=CC2/[CC1+CC2+CC3]
CCi3=CC3/[CC1+CC2+CC3]

Next, density values D for controlling the ink feeding rates of the printing machine are calculated (step S8). Where densities at the three control points are CDi1, CDi2 and CDi3, a density value is derived from the following equation:
D=CCi1×CDi1+CCi2×CDi2+CCi3×CDi3

Steps S3 to S8 above are executed for the reference image data obtained at step S1 and the image data read at step S2, to determine densities D at the corresponding control points.

By comparing the densities D of the two image data, the ink feeding rates of the printing machine are calculated. The ink feeding rates are adjusted based on the results of the calculation (step S9).

Where density values D of YMCK colors are compared as in the embodiment described above, for example, the ink feeding rates are adjusted based on the differences between the density values D. Where RGB density values or L*a*b* calorimetric values are compared, instead of the density values D, an adjustment is made by converting their differences into differences in the feeding rate of YMCK color inks. Such a technique for adjusting the ink feeding rates based on the differences in calorimetric values (color differences) is disclosed in U.S. Pat. No. 2,505,434, for example.

The tone control method according to this invention described above, by using a plurality of control points, can always properly calculate density values D for controlling the ink feeding rates of the printing machine, thereby obtaining proper prints. In the embodiment described above, three control points are determined for each of the areas E1-E6 for expediency of description. A greater number of control points may be determined for each of the areas E1-E6 to enable a more precise calculation of density values D for controlling the ink feeding rates of the printing machine.

In the embodiment described above, the tone control method according to this invention has been described as applied to the printing machine having the image pickup station 60 online. The tone control method according to this invention may be applied to a print tone measuring apparatus of the off-line console type (or the separate type).

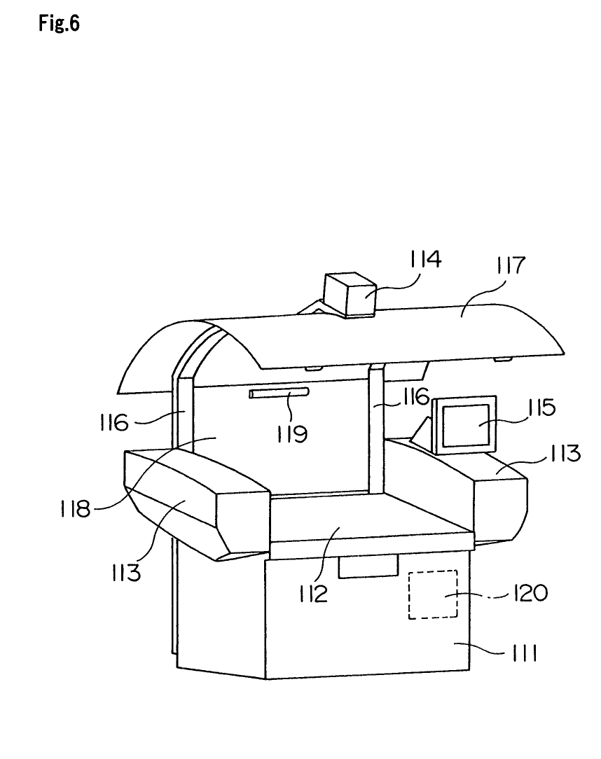

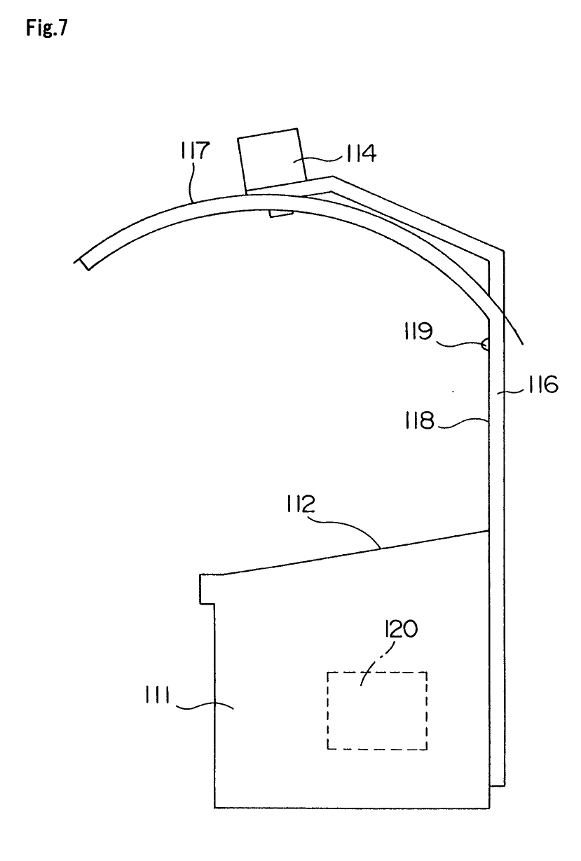

Such a print quality measuring apparatus will be described hereinafter. FIG. 6 is a perspective view of a print quality measuring apparatus employing this invention. FIG. 7 is a side view of the apparatus. It is to be noted that light sources 113 and a control panel 115 are omitted from FIG. 7.

This print quality measuring apparatus includes a table 112 disposed above a frame 111, a pair of light sources 113 arranged at right and left sides of the table 112, an image pickup unit 114 disposed above the table 112, a control panel 115 disposed above one of the light sources 113, an upper light-shielding plate 117 and a rear light-shielding plate 118 supported by a pair of posts 116, an auxiliary light source 119 attached to the rear light-shielding plate 118, and a control unit 120 mounted inside the frame 111 for controlling the entire apparatus.

The table 112 is shaped planar for receiving a print thereon. The table 112 has a surface in the form of a suction plate for holding the print by static electricity or vacuum suction. The surface of the table 112 is inclined about 110 degrees for facility of operation by the operator. The print held by suction on the inclined surface of the table 112 is illuminated by the pair of light sources 113 arranged at the opposite sides.

The image pickup unit 114 disposed above the table 112 has a digital camera for separating, with a dichroic mirror, light emitted from the light sources 113 and reflected from the surface of the print into the three primary color components of RGB, and receiving the individual components with separate CCD arrays. With this image pickup unit 114, RGB data can be obtained from the print.

The control panel 115 is the touch panel type in the form of an LCD monitor having a pressure sensitive input function. This control panel 115 acts as both a display device and an input device, and is connected to the control unit 120 described hereinafter.

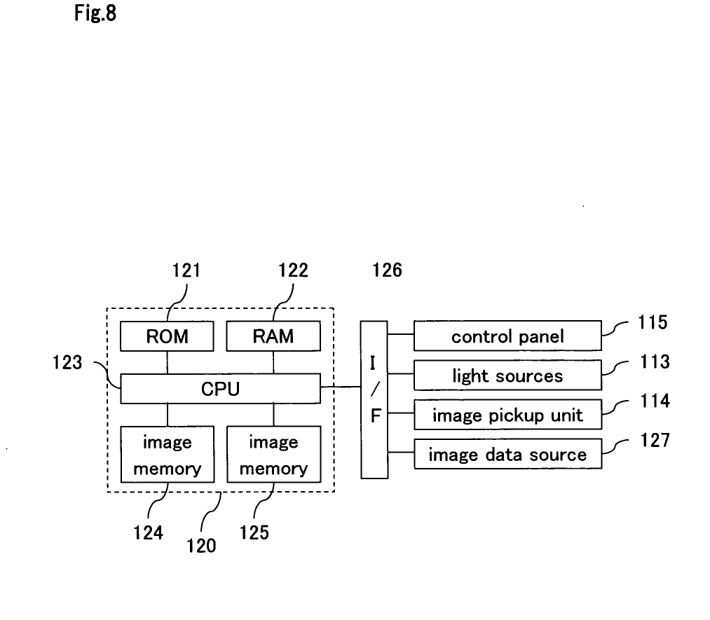

FIG. 8 is a block diagram showing a principal structure of the control unit 120.

This control unit 120 includes a ROM 121 for storing operating programs necessary for controlling the apparatus, a RAM 122 for temporarily storing data and the like during a control operation, a CPU 123 for performing logic operations, and a first and a second image memories 124 and 125. The control unit 120 is connected through an interface 126 to the control panel 115, light sources 113 and image pickup unit 114 noted above. The control unit 120 is connected also to an image data source 127 storing image data to be printed, such as a hard disk or an image processing device.

Referring again to FIGS. 6 and 7, the upper light-shielding plate 117 supported by the pair of posts 116 has a curved configuration extending in the fore and aft direction of the print quality measuring apparatus. The light-shielding plate 117 is installed in order to intercept light, such as light from indoor light sources, that would constitute a regular reflection from the table 112. On the other hand, the rear light-shielding plate 118 supported between the pair of posts 116 serves to intercept light coming from behind the print quality measuring apparatus.

The auxiliary light source 119 attached to the rear light-shielding plate 118 serves to compensate for a lack of light on the table 112 caused by the upper light-shielding plate 117 and rear light-shielding plate 118. The auxiliary light source 119 is in the form of a fluorescent light or the like, which is turned off when reading a print with the image pickup unit 114.

In performing a tone control using the print quality measuring apparatus having the above construction, image data to be used as reference is fetched first. This reference image data is stored in the first image memory 124 shown in FIG. 8. The reference image data is supplied from the image data source 127 shown in FIG. 8. The reference image data is obtained by operating the image pickup unit 114 to read the image of reference paper placed on the table 112.

Next, image data is obtained from an actual print by operating the image pickup unit 114 to read the image of the print placed on the table 112. The image data obtained from the actual print by the image pickup unit 114 is stored by the second image memory 125 shown in FIG. 8.

Then, as in the foregoing embodiment, a plurality of control points to be used for the tone control are determined, and the described steps are executed to calculate weight factors and obtain density values D for controlling the ink feeding rates of the printing machine.

In the embodiment described hereinbefore, the weight factors are calculated by using the color spread, color purity and dot percent of each control point. However, the weight factors may be calculated by using at least one of these parameters.

This invention may be embodied in other specific forms without departing from the spirit or essential attributes thereof and, accordingly, reference should be made to the appended claims, rather than to the foregoing specification, as indicating the scope of the invention.

This application claims priority benefit under 35 U.S.C. Section 119 of Japanese Patent Application No. 2004-116570 filed in the Japanese Patent Office on Apr. 12, 2004, the entire disclosure of which is incorporated herein by reference.

1. A tone control method for creating data for controlling ink feeding rates of a printing machine, by comparing color values derived from data serving as a reference and color values derived from data obtained by reading an image from an actual print, said method comprising:
a control point determining step for determining a plurality of control points for use in a tone control;
a weight factor calculating step for calculating a weight factor of each of the control points determined in said control point determining step; and
a color value calculating step for calculating color values for controlling the ink feeding rates, based on color values and the weight factor of each of the control points.

2. A tone control method as defined in claim 1, wherein said weight factor calculating step is executed to calculate a weight factor by using at least one of a color spread of each control point, a color purity of each control point and a dot percent of each control point.

3. A tone control method as defined in claim 2, wherein said weight factor calculating step is executed to determine the color spread of each control point by using a color distribution of an area around each control point.

4. A tone control method as defined in claim 1, wherein said color value calculating step is executed to calculate color values for controlling the ink feeding rates by totaling, for all of the control points, products of the color values and the weight factor of each of the control points.

5. A tone control method as defined in claim 1, wherein said image data serving as a reference is image data obtained by reading an image on reference paper.

6. A tone control method as defined in claim 1, wherein said control point determining step is executed to determine a plurality of control points for each area corresponding to ink keys in each ink well of the printing machine.

7. A tone control method for creating data for controlling ink feeding rates of a printing machine, by comparing color values derived from image data serving as a reference and color values derived from image data obtained by reading an image from an actual print, said method comprising:
a control point determining step for determining a plurality of control points for use in a tone control;
a weight factor calculating step for calculating a weight factor of each of the control points determined in said control point determining step, by multiplying at least one of a color spread of each control point, a color purity of each control point and a dot percent of each control point by at least one of the color spread of each control point, the color purity of each control point and the dot percent of the control point; and
a color value calculating step for calculating color values for controlling the ink feeding rates, by totaling, for all of the control points, products of the color values and the weight factor of each of the control points.

8. A tone control method as defined in claim 7, wherein said image data serving as a reference is image data obtained by reading an image on reference paper.

9. A tone control method as defined in claim 7, wherein said control point determining step is executed to determine a plurality of control points for each area corresponding to ink keys in each ink well of the printing machine.
